(19) United States
(12) Patent Application Publication
(10) Pub. No.: US 2010/0021260 A1
(43) Pub. Date: Jan. 28, 2010

(54) Anchoring Element

(76) Inventors: Pietro Bianchi, Gams (CH); Roger Tognini, Heerbrugg (CH); Bernhard Sander, Munich (DE); Clemens Lutz, Buchs (CH); Joerg Appl, Buchs (CH); Walter Konrad, Eschenbach (CH)

Correspondence Address: ABELMAN, FRAYNE & SCHWAB, 666 THIRD AVENUE, 10TH FLOOR, NEW YORK, NY, 10017, US

(21) Appl. No.: 12/460,885

(22) Filed: Jul. 23, 2009

(30) Foreign Application Priority Data
Jul. 24, 2008 (DE) 10 2008 040 694.5

(51) Int. Cl. F16B 13/06; F16B 13/04

(52) U.S. Cl. 411/72; 411/78

(57) ABSTRACT

An anchoring element for being mounted on a shaft (52; 62; 72; 92) of a fastening element (51; 61; 71; 91) has a through-opening for the shaft (52; 62; 72; 92) and a strip extending around the through-opening (12; 32; 82) over an angular region of more than 360°.

### BACKGROUND OF THE INVENTION

1. Field of the Invention

The present invention relates to an anchoring element having a through-opening for being mounted on a shaft of a fastening element which has an outer profile. The present invention also relates to a fastening assembly anchorable in a borehole of a constructional component with a hardenable mass and having a fastening element and at least one anchoring element, and to a fastening arrangement with such a fastening assembly.

2. Description of the Prior Art

It is known to chemically anchor a fastening element in a borehole with a hardenable mass that is brought into the borehole before or after insertion of the fastening element in the borehole. The fastening element can be formed, e.g., as a threaded rod provided along its entire longitudinal extent with a thread that forms the outer profile. When such a fastening element is chemically anchored, a rupture can occur along a contact region between the shaft and the hardenable mass and/or along a contact region between the borehole wall and the hardenable mass.

Bonding of the hardened mass to the borehole wall and, thus, anchoring of the fastening element in the borehole can be improved by cleaning the borehole and, in particular, by cleaning the borehole wall. Cleaning of the borehole involves additional expenses and requires separate auxiliary means necessary to achieve advantageous results and which are not always available to the user.

German Patent DE 24 23 433 A1 discloses a fastening element formed as an anchor bar and anchorable in a borehole with a hardenable mass. The anchor bar has, in its thread-free region, radially projecting bristles which clean a borehole wall filled with a hardenable mass during driving of a fastening element in.

The drawback of the fastening element disclosed in DE 24 23 433 A1 consists in that the fastening element can be loaded only after the hardenable mass has hardened.

U.S. Pat. No. 1,688,087 discloses a fastening element anchorable in a borehole with a hardenable mass and having a shaft with a thread-shaped outer profile and a plurality of flat ring-shaped anchoring elements each having a through-opening for the shaft and an outer diameter greater than a nominal diameter of the borehole in which the fastening element is being anchored. The fastening element is inserted in the borehole as a unitary element, i.e., with anchoring elements being arranged on its shaft. The flat ring-shaped anchoring elements provide for mechanical anchoring of the fastening element in a borehole until the hardenable mass, which is introduced in the borehole before or after the insertion of the fastening element, sufficiently hardens.

The drawback of the fastening element described above consists in that in view of the shaped outer profile of the shaft of the fastening element, the flat ring-shaped anchoring elements easily incline in a plane extending transverse to the longitudinal axis of the shaft and, as a result, the shaft section that projects from the borehole after setting of the fastening element, does not extend perpendicular to the surface of the constructional component. The subsequent adjustment of the shaft generally is possible, if at all, only within certain limits as the adjustment is effected against a counter-force generated by the fastening element.

Further, for cleaning of the borehole wall sufficient for a chemical anchoring and for an adequate anchoring of the fastening element, a sufficient number of anchoring elements should be provided and which are separately mounted on the shaft of the fastening element, which is expensive.

Accordingly, an object of the present invention is to provide an anchoring element that can easily be mounted on a fastening element shaft with a shaped outer profile and that reduces the costs of setting of a fastening assembly.

Another object of the present invention is to provide a chemically anchorable fastening assembly with a fastening element and at least one anchoring element.

A further object of the present invention is to provide a fastening arrangement with the inventive fastening assembly and which permits to reduce the setting costs.

### SUMMARY OF THE INVENTION

These and other objects of the present invention, which will become apparent hereinafter, are achieved by providing an anchoring element formed of a strip extending around the through-opening of the anchoring element over an angular region of more than 360°.

In the mounted condition, the strip completely surrounds the shaft of the fastening element at least one time, with the inner edge of the strip engaging in the outer profile of the shaft at least in one region. Advantageously, the strip extends around the through-opening over an angular region which is a multiple of 360°. With an anchoring element formed as a strip, the pitch of the outer profile on the shaft can be compensated. After setting of the fastening element provided with at least one inventive anchoring element, the adjustment of the fastening element in most cases is unnecessary or can be easily carried out.

Advantageously, the through-opening has a shape corresponding to the contour of the shaft of the fastening element and, thus, can have a shape that deviates from a circle. Advantageously, the strip has along its longitudinal extent, a constant strip width, so that the through-opening is concentrically arranged with respect to the outer circumference of the anchoring element or to the radially outer edge of the strip-forming. According to an alternative embodiment of the present invention, the strip has along its longitudinal extent a variable strip width, so that the width of the material section between the radial boundary of the through-opening and the outer circumference of the anchoring element-forming generatrix varies in the circumferential direction.

Advantageously, the strip is helix-shaped. This anchoring element can be easily arranged on a shaft of a fastening element. The pitch of the strip is so selected that it is advantageously greater than any available pitch of the shaft outer profile. Dependent on the pitch of the helix-shaped strip, an advantageous guidance or alignment of the fastening element in the set condition becomes possible.

Advantageously, the strip has a non-circular outer contour having at least two turning points over an angular region of 360°, so that the outer contour does not completely bear against the borehole wall. During driving of a fastening element with such an anchoring element in a borehole, only a section of the anchoring element brushes along the borehole wall, so that a smaller force and, thus, smaller expenses are required for setting the fastening element. In addition to an oval, in plan view, shape of the outer contour of the strip with two turning points, the strip can have an outer contour shape with three or more turning points. Advantageously, the comers oft turning points are rounded. Between the two turning points, the strip sections extend in form of an arc.

Advantageously, the strip has, in addition to a non-circular outer contour, a non-circular inner contour that likewise has at least two turning points over an angular region of 360°, so that the strip bears against the shaft of the fastening element only sectionally and in some regions is spaced from the shaft. In the region of the strip section spaced from the shaft, through-openings for the hardenable mass are provided. In addition to an oval, in plan view, shape of the inner contour of the strip with two turning points, the strip can have an inner contour shape with three or more turning points. Advantageously, the corners of the turning points are rounded. Between the two turning points, the strip sections extend in form of an arc.

Advantageously, turning points of two adjacent coils of the strip are, respectively, arranged relative to each other at an offset angle, which insures an advantageous cleaning of the borehole wall with smaller expenditure of force for setting the fastening element. This is insured by a radially distributed arrangement of the sections of the strip, which bear against the borehole wall, over the longitudinal extent of the strip.

Advantageously, the offset angle is determined according to the following equation

$$α = \frac{360 \cdot n}{ξ \cdot ω} [ \cdot ]$$

where:
n—the number of desired repeated contacts of the radial outer side of a strip coil with the borehole wall. Advantageously, two or more repeated contacts per coil are provided.
ξ—is a total number of coils in a plan view over 360° or is equal to

$$ξ = \frac{{h}_{Helix}}{{P}_{Helix}}$$

where:
h—is an entire axial height of the strip, and
P—is a pitch of one coil of the strip;
ω—is a number of turning points in a coil in the plan view over 360°. When the strip has, in the plan view, a shape of an oval, the number of turning points is equal 2. Correspondingly, the number of turning points of a three-sided polygon equals 3, of a four-sided polygon equals 4, with a clover-leaf shape, also equals 4, and of a pentagon equals 5, etc.
α—is an offset angle, i.e., the angle by which the turning points of two adjacent coils of the strip are offset relative to each other.

According to an alternative embodiment, the strip includes a plurality of flat ring-shaped members connected with each other by respective adjacent to each other, circumferential sections or edge sections. Advantageously, the flat ring-shaped members are alternatively connected with each other at respective radially opposite circumferential sections to form the anchoring element. Thereby, for adaptation of the length of the anchoring element to the anchoring length of the fastening element, the ring-shaped members are compressed or are pulled away like an accordion. The through-opening for the shaft of the fastening element is formed by inner openings of the flat ring-shaped members. The flat ring-shaped members are formed, e.g., as one-piece element and are correspondingly folded to form an anchoring element. According to an alternative embodiment, the flat ring-shaped members are connected with each other by connection points, e.g., solder or glue points, or by clamping or holding means.

Preferably, the radially outer edge of the strip is provided with a profile that insures an easy adaptation of the anchoring element to the contour of the borehole. E.g., the profile can be formed by recesses which open radially outwardly. The recesses advantageously are formed as slots limited at one side and extending from the outer edge in a direction toward the through-opening. The sections of the anchoring element, which are located between the recesses, form easily deflectable lamellas. This insures adaptation of the anchoring element to a borehole profile during the insertion of the anchoring element even when the anchoring element is formed of a very stiff material. Advantageously, different types of recesses are provided on the outer edge of the anchoring element. E.g., one type is represented by slots which form displaceable lamellas on the outer edge. Between the slots, there is provided a second type of slots which additionally fan out the edge of the anchoring element located therebetween. Further, the profile can be formed by at least one, opening radially outwardly, notch that is provided on the outer edge of the anchoring section.

Advantageously, the radially inner edge of the strip of the anchoring element is also provided with a profile that insures an easy adaptation of the anchoring element to the contour of the shaft. E.g., the profile can be formed by recesses which open radially inwardly. The recesses advantageously are formed as slots limited at one side and extending from the inner edge in a direction of the outer edge of the strip or radially outwardly. The sections of the anchoring element, which are located between the recesses, form easily deflectable lamellas. This insures adaptation of the anchoring element to a shaft profile upon mounting of the anchoring element on a fastening element even when the anchoring element is formed of a very stiff material. Advantageously, different types of recesses are provided on the inner edge of the anchoring element. E.g., one type is represented by slots which form displaceable lamellas on the inner edge.

Between the slots, there is provided a second type of slots which additionally fan out the edge of the anchoring element located therebetween.

In an advantageous, flexible embodiment of the present invention, both the inner edge and the outer edge are provided with a respective profile. The two profiles can at least partially overlap in radial direction at least in some regions.

Advantageously, the strip has along its extension a wavy contour that insures a sufficient stiffness of the anchoring element when the anchoring element is driven in a borehole. The strip waviness is provided, e.g., in direction of the longitudinal extension of the strip and/or its transverse extension.

For an advantageous anchoring of element on the borehole wall the thickness of the strip amounts advantageously to from 0.01 mm to 2 mm, preferably, from 0.05 mm to 1 mm.

Further, advantageously, the strip has in the strip plane different thicknesses, which insures that the deformation behavior of the anchoring element, in particular, during driving of the fastening element with the mounted thereon, anchoring member in the borehole, can be advantageously modified. In a particular advantageous embodiment, the thickness increases radially outwardly from the through-opening. Thereby, an advantageously large amount of material for mechanical connection of the anchoring element with the wall is available in a contact region of the anchoring element with the wall. According to another advantageous embodiment of the present invention, the thickness increases from the outer edge in the radial direction toward the through-opening. Thereby, an advantageously large amount of material for mechanical connection of the anchoring element with the shaft is available in a contact region of the anchoring element with the shaft.

Further, the thickness of the strip can increase, on one hand, from the through opening in the radial direction outwardly and, on the other hand, from the outer edge in the radial direction toward the through opening. In this case, the region of the strip with the largest material thickness is located between the outer and inner ends of the strip.

Advantageously, the strip has at least one through-opening for the hardenable mass. Thereby, during insertion of the anchoring element in a borehole which has already been filled with the hardenable mass, a displaced portion of the hardenable mass easily penetrates into anchoring element that can be, thus, completely enveloped by the hardenable mass. When the borehole is filled with the hardenable mass after the fastening element has been driven in, the poured mass can flow through the at least one through-opening unhindered up to the borehole bottom, to the shaft of the fastening element, and to the borehole wall.

According to an advantageous embodiment, the at least one through-opening in provided in the outer circumference of the anchoring element. Alternatively or in addition, in the anchoring element or in the strip plane, there is provided at least one, circumferentially closed opening for the hardenable mass. Advantageously, a plurality of through-openings spaced from each other is provided along a longitudinal extension of the strip, which are advantageously offset with respect to each other from coil to coil in a multi-coil strip. This insures an advantageous anchoring of the fastening element in the hardened mass and the stiffening of the hardened mass.

Advantageously, the strip is formed of metal, preferably, sheet metal, whereby the anchoring element has a sufficient stiffness. A simple and economical manufacturing of the inventive anchoring element can be insured in particular by a stamping/bending process. Alternatively, the strip-shaped anchoring element can be formed by a winding process.

According to an alternative embodiment, the anchoring element is formed of a plastic material, preferably of a fiber-reinforced plastic material. In this case, a simple and economical manufacturing of the anchoring element is insured with an injection-molding process.

According to an advantageous embodiment, the anchoring element is formed of a non-conductive material. In applications where no current should be conducted, e.g., at attachment of railroad ties, the strip-shaped anchoring element insures, due to the projecting inwardly, retaining sections, a sufficient distance between the shaft and the borehole wall and prevents current flow from a constructional component in the shaft of the fastening element.

Alternatively, the anchoring element can be produced from a material other than metal or plastic material as long as the used material insures a sufficient mechanical anchoring of a fastening element in a borehole until hardening of the hardenable mass.

An inventive fastening assembly, which is anchorable in a borehole with a hardenable mass, includes a fastening element having a shaft, provided with an outer, and at least one anchoring element having a through-opening for the shaft and formed of a strip that extends around the through-opening over an angular region greater than 360°.

The inventive fastening assembly can be easily produced and enables its easy setting in a borehole of a constructional component, e.g., in a wall or a ceiling. The outer profile of the shaft is, e.g., a thread.

The at least one strip-shaped anchoring element of the fastening assembly can have separate or all of the features of the anchoring element(s) described above.

Advantageously, a plurality of anchoring elements are mounted on a shaft of a fastening element at a distance from each other. Thereby, an advantageous anchoring of a fastening element in a borehole and an advantageous reinforcement of the hardened mass is insured.

Advantageously, different types of anchoring elements are provided on the shaft, which permits to combine, if necessary, different anchoring characteristics at different anchoring depth. E.g., strip-shaped anchoring elements can be combined, on a shaft of a fastening element, with sleeve-shaped anchoring elements or flat ring-shaped anchoring elements.

An inventive fastening arrangement for anchoring a fastening assembly with a hardenable mass in a borehole having a nominal diameter, includes a fastening assembly with a fastening element and at least one anchoring element mounted on the fastening element and having an outer diameter greater than nominal diameter of the borehole.

During driving of the fastening element or the fastening assembly in a borehole, simultaneously, cleaning of the borehole is carried out as a result of brushing of the anchoring element along the borehole wall. As a result, drillings, which are produced during drilling of the borehole, are accumulated at the borehole bottom and, if required, are accumulated in the hardenable mass, and are not released anymore in a large amount into environment. A separate cleaning of the borehole before setting of the fastening assembly or the fastening element is not any more necessary, despite of which high end loads with the anchored fastening assembly are achieved. Further, the anchoring assemblies provide for protection against splash of the hardenable mass during driving of the fastening assembly in the borehole.

With the elimination of the cleaning step, the reliability is increased, and the setting of the fastening assembly is accelerated. No additional devices are necessary, and the surrounding air is not contaminated by drillings. Further the fastening assemblies with the inventive anchoring element insure, a sufficient covering of the shaft of the fastening element along its entire anchoring length with a hardenable mass in the borehole.

The at least one strip-shaped anchoring element or the fastening assembly can have separate or all features of the above-described anchoring element and the fastening assembly.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

The drawings show:

FIG. 1 a side view of a first embodiment of an anchoring element according to the present invention;

FIG. 2 a side view of a second embodiment of an anchoring element according to the present invention;

FIG. 3 a plan view of a third embodiment of an anchoring element according to the present invention;

FIG. 4 a partial front view of the anchoring element shown in FIG. 3;

FIG. 5 a plan view of a fourth embodiment of an anchoring element according to the present invention;

FIG. 6 a cross-sectional view of a fastening arrangement with a fastening assembly according to the present invention;

FIG. 7 a schematic side view of a fastening assembly according to the present invention;

FIG. 8 a cross-sectional view of another embodiment of a fastening assembly according to the present invention; and

FIG. 9 a side view of another embodiment of a fastening assembly according to the present invention.

Basically, in the figures, the same elements are designated with the same reference numeral.

### DETAILED DESCRIPTION OF THE PREFERRED EMBODIMENTS

A helices-shaped anchoring element 11 according to the present invention, which is shown in FIG. 1, is formed of a strip and has a through-opening 12 for a shaft of a fastening element. The helix-shaped anchoring element 11 extends over an angular region of more than 360°. In the embodiment shown in FIG. 1, the anchoring element 11 extends thrice around the opening 12, which corresponds to an angular region of 1080°. The multiple of 360° that defines the extent of the strip-shaped anchoring element 11 need not be a whole number. E.g., if the strip extends over an angular region of 480°, it would extend 1.3 times around the through-opening 12. The anchoring element 11 can be easily adapted to site condition or different loads, e.g., by being cut to a length.

The anchoring element 11 has an inner edge 13 adjacent to the through-opening 12, and an outer edge 14 remote from the through-opening 12. The anchoring element 11 is formed of metal, preferably, sheet steel, by a stamping/bending process.

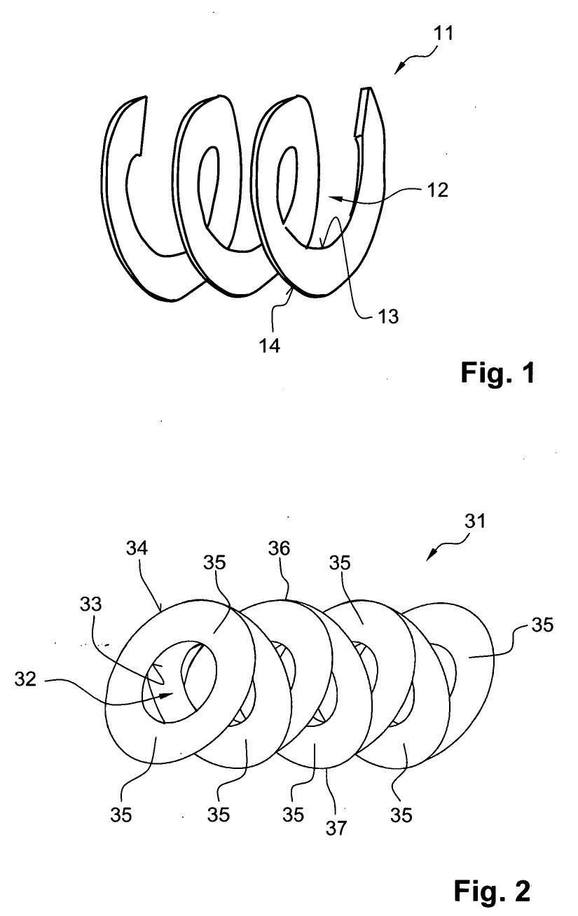

A strip-shaped anchoring element 31, which is shown in FIG. 2, includes a plurality of flat ring-shaped members 35 connected with each other by adjacent to each other, circumferential suction 36 and 37. The strip-shaped anchoring element 31 extends over an angular region of more than 360° and, in the embodiment shown in FIG. 2, the anchoring element 31 extends seven times around the through-opening 32, which corresponds to an angular region of 2050°. Each member 35 of the anchoring element 31 has an inner edge 33 adjacent to the through-opening 32, and an outer edge 34 remote from the through-opening 32. Advantageously, the anchoring element 31 is formed of a plastic material, preferably, of fiber-reinforced plastic material, by an injection-molding process. Separate flat ring-shaped members 35 are connected with each other by separate connection points such as solder or weld points, to form the anchoring element 31.

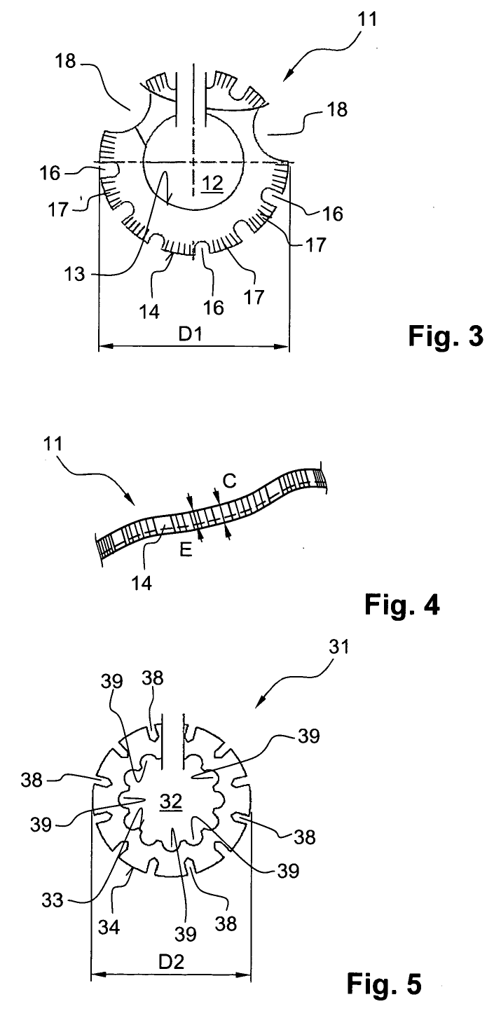

Below, with reference to FIGS. 3-5, different types of profiles which anchoring elements 11, 31, 81 and 101 shown in FIGS. 1, 2, 8, and 9, or at least their respective sections can have, will be described.

In FIGS. 3-4, the outer edge 14 of the strip-shaped anchoring element 11 has a profile formed by recesses 16 opening radially outwardly. The recession 16 form a plurality of easily deflectable lamellas. Between most of the recesses 16, there are provided slots 17 extending from the outer edge 14 radially inwardly. The slots 17 fan out the free edge of the anchoring element 11 at least in some regions, which insures an easy adaptation of the anchoring element 11 to a borehole wall. In the outer edge 14 of the strip-shaped anchoring element 11, there are provided two through-opening 18 for a hardenable mass. The anchoring element 11 has an outer diameter D1.

The anchoring element 11 has, in the flat ring plane, a wavy profile (see FIG. 4) and has, in the strip plane, different thicknesses C and E, with the thicknesses C and E increasing from the through-opening 12 radially outwardly.

As shown in FIG. 5, the outer edge 34 of the strip-shaped anchoring element 31 has a profile formed by opening radially outwardly, recesses 38 which form a plurality of easily deflectable lamellas. Additionally, the inner edge 33 of the strip-shaped anchoring element 31 likewise is provided with a profile formed by a plurality of circumferentially spaced, opening radially inwardly, recesses 39. The anchoring element 11 has an outer diameter D2.

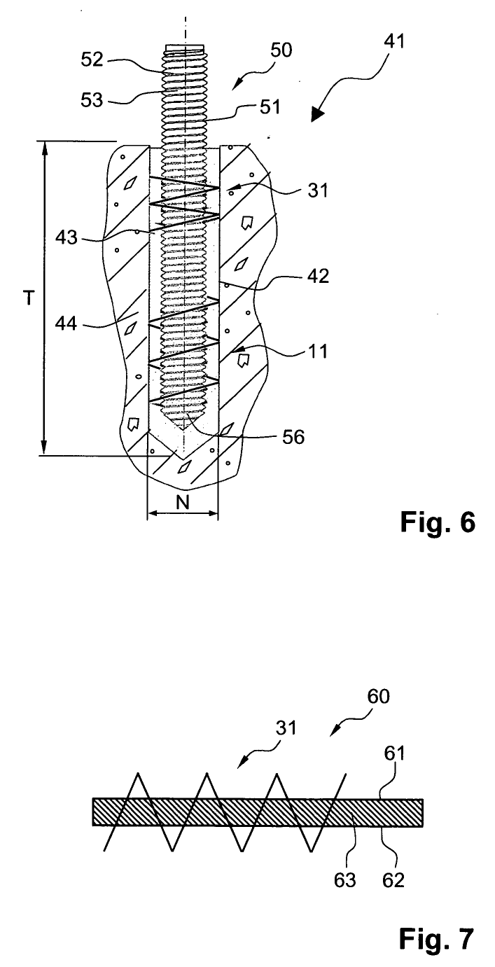

FIG. 6 shows a fastening arrangement 41 for anchoring a fastening assembly 50 in a borehole 42 with a hardenable mass 43.

The fastening assembly 50 includes a fastening element 51 having a shaft 52 with an outer thread that forms an outer profile 53, and two spaced from each other, anchoring elements 11 and 31 which are formed as described above. The strip-shaped anchoring element 11 is provided on a setting direction end 56 of the shaft 52 at a distance from the anchoring element 31.

For setting the fastening assembly 50 in a constructional component 44, firstly, a borehole 42 is formed with a drill, with the nominal diameter N of the produced borehole 42 being selected so that it is smaller than the outer diameter D1 of the anchoring element 11 and smaller than the outer diameter D2 of the anchoring element 31. The depth T of the borehole 42 is determined, on one hand, by the necessary anchoring length for the fastening element 51 and, on the other hand, by a space in front of the fastening element 51 for receiving the drillings produced during drilling of the borehole 42.

Finally, the borehole 42 is filled with a predetermined amount of the mass 43, and the fastening assembly 50 is driven in the borehole 42 with the setting direction-side end 56 of the fastening element 51 first. The driving of the fastening assembly 50 in the borehole 42 can be effected manually or mechanically. As the fastening assembly 50 is driven in the bore 42, the anchoring elements 11 and 31, which are arranged on the shaft 52 of the fastening element 51, brush along the borehole wall, whereby a major part of the drillings, which are bonded to the wall, are removed from the wall, and become intermixed with the mass 43 or are displaced to a borehole bottom. The anchoring elements 11 and 31 can be pushed onto the shaft 52 or, e.g., be screwed thereon.

During insertion of the fastening assembly 50 in the borehole 42, the hardenable mass 43 flows through and around the anchoring elements 11 and 31 through the through-openings 18 and the recesses 18 and 3 and 39. Thereby, the hardenable mass 43 and the drillings located therein uniformly intermix, and the anchoring elements 11 and 31 become completely embedded in the hardenable mass 43 after the mass 43 has been hardened.

Alternatively, firstly, the fastening assembly 50 is driven in the borehole 42 and than the hardenable mass 43 is poured into the borehole 42. According to another alternative embodiment, firstly, a small, predetermined amount of the hardenable mass 43 is poured into the borehole, then the fastening assembly 50 is driven in the borehole 42 and, finally, the remaining free space of the borehole 42 is filled with a further amount of the hardenable mass 43.

The shaft 52 of the fastening element 51 can also be provided with an injection bore through which the hardenable mass 43 is brought into the borehole 42 after the fastening element 51 was driven in or during the driving of the fastening element 51 in the borehole 42.

Even before the hardenable mass 43 hardens, the fastening assembly 50 and, thereby, the fastening element 51 can be loaded to a certain limited level because at least the anchoring elements 11 and 31 mechanically anchor the fastening element 51 in the borehole 42. After the hardenable mass 43 hardens, the set fastening element 51 can be loaded to a maximum allowable level.

Because the outer edge 14 of the anchoring element 11 and the outer edge 34 of the anchoring element 31 engage in the borehole wall at least in some regions, an adequate contact surface is available, which permits to use the fastening assembly 50 in a crushed concrete.

Instead of different anchoring elements 11 and 31, a number of the same anchoring elements 11 or 31 can be provided on a shaft of fastening element.

Dependent on the requirements, a set fastening element should meet, a single anchoring element can be provided on the shaft 52 of the fastening element 51.

The fastening assembly 60, which is shown in FIG. 7 includes a strip-shaped anchoring element 31 mounted on the shaft 52 which has a thread-formed outer profile 63. The anchoring element 31 is formed of a plurality of flat ring-shaped members 35 connected with each other, as it has already been discussed above, by adjacent to each other, circumferential sections of respective members 35.

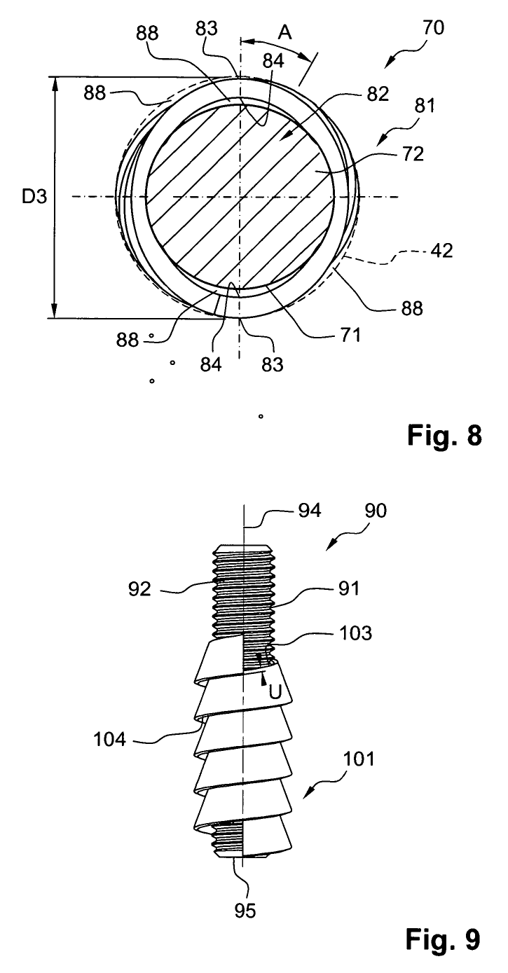

A fastening assembly 70, which is shown in FIG. 8, includes an anchoring element 81 in form of a strip that extends around a through-opening 82 over an angular region of more than 360°. The strip has a non-circular outer contour and a non-circular inner contour having, respectively, at least two turning points 83 and 84 in the angular region of 360°. The turning points 83 and 84 of two adjacent coils of the strip-shaped anchoring element 81 are arranged relative to each other in the embodiment shown in FIG. 8 with an offset angle A of 12.5°.

The turning points 83 and 84 are, respectively, rounded, and the sections of the strip-shaped anchoring element have each an arcuate shape. The free space between the strip-shaped anchoring element 81 and the outer side of the shaft 72 of the fastening element 71 and the free space between the strip-shaped anchoring element 81 and the wall of the borehole 42 form through-openings 88 for the hardenable mass. The maximum diameter D3 of the anchoring element 81 is greater than the nominal diameter of a borehole into which the fastening assembly 70 is to be set.

A non-exclusive modification of the fastening assembly 70, which is shown in FIG. 9, includes a fastening element 91 having a shaft 92 provided with an outer profile-forming thread, and a strip-shaped anchoring element 101 formed as a helix. An outer edge 104 of the strip-shaped anchoring element 101 projects from the outer side of the shaft 92 and extends at an acute angle to a longitudinal axis 94 of the fastening element 91, whereby a plurality of cones, which widen in direction of an end 95 of the shaft 92, are formed. The outer edge 104 overlaps an adjacent thereto, inner edge 103 of the anchoring element 101 by an overlap U. the cone-shaped form of the anchoring element 101 insures that the fastening assembly 90 has advantageous repeated expansion characteristics and, therefore, is suitable for use in a crushed construction component, e.g., in a crushed concrete.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An anchoring element for being mounted on a shaft (52; 62; 72; 92) of a fastening element (51; 61; 71; 91), with the shaft (52; 62) having an outer profile (53; 63), the anchoring element comprising a through-opening for the shaft (52; 62; 72; 92) and a strip extending around the through-opening (12; 32; 82) over an angular region of more than 360°.

2. An anchoring element according to claim 1, wherein the strip is helix-shaped.

3. An anchoring element according to claim 1, wherein the strip has a non-circular outer contour having at least two turning points (83) in the angular region of 360°.

4. An anchoring element according to claim 3, wherein the strip has a non-circular inner contour having at least two turning points (84) in the angular region of 360°.

5. An anchoring element according to claim 3, wherein the turning points (83) of the outer contour and the turning points (84) of the inner contour of two adjacent coils of the strip are, respectively, offset relative to each other by an offset angle (A).

6. An anchoring element according to claim 1, wherein the strip comprises a plurality of flat ring-shaped members (35) connected with each other by respective, adjacent to each other, circumferential sections (36, 37).

7. An anchoring element according to claim 1, wherein at least one of radially outer edge (14; 34) and radially inner edge (13; 33) of the strip is provided with a profile.

8. An anchoring element according to claim 1, wherein the strip has a wavy shape along an extension thereof.

9. An anchoring element according to claim 1, wherein the strip has at least one through-opening (18) for a hardenable mass (43).

10. A fastening assembly for being anchored in a borehole (42) with a hardenable mass (43), the fastening assembly comprising a fastening element (51; 61; 71; 91) having a shaft (52, 62; 72; 92) having an outer profile (53; 63); and an anchoring element (11; 31; 61; 81; 101) for being mounted on the shaft (52) of the fastening element (52; 62; 72; 92) and having a through-opening for the shaft (52; 62; 72; 92) and a strip extending around the through-opening (12; 32; 82) over an angular region of more than 360°.

11. A fastening assembly according to claim 10, comprising a plurality of fastening elements (11; 31) provided on the shaft (52) of the fastening element (51) at a distance from each other.

12. A fastening assembly according to claim 11, wherein the plurality of anchoring elements (11; 31) is formed of different types of anchoring elements.

13. A fastening arrangement (41) for anchoring, in a borehole (42) having a nominal diameter (N), a fastening assembly (50; 60; 70; 90) with a hardenable mass (43), the fastening assembly comprising a fastening element (51; 61; 71; 91), and an anchoring element (11; 31; 81; 101) arranged on the fastening element, having a maximum outer diameter (D1; D2; D3; D4) greater than the nominal diameter (N) of the borehole (42), and including a through-opening for the shaft (52; 62; 72; 92) and a strip extending around the through-opening (12; 32; 82) over an angular region of more than 360°.
